(19) United States
(12) Patent Application Publication
(10) Pub. No.: US 2003/0205145 A1
(43) Pub. Date: Nov. 6, 2003

(54) Separable coffee maker

(76) Inventor: Kwei Tang Chang, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/138,415

(22) Filed: May 6, 2002

(51) Int. Cl. A47J 31/00

(52) U.S. Cl. 99/303

(57) ABSTRACT

The present invention provides a separable coffee maker, which comprises a base, a filter unit, a guide pipe, and a container. The base has a receiving space therein. The filter unit is disposed in the receiving space of the base. Through holes are formed on the guide pipe, which is disposed above the filter unit. The container has an inner pipe body therein. The inner pipe body is extended upwards from the bottom portion of the container. The container is separately placed on the base. The inner pipe body of the container is slipped onto the guide pipe. A separable coffee maker whose container can be separately taken out is thus formed.

### FIELD OF THE INVENTION

The present invention relates to a separable coffee maker and, more particularly, to a pressure type coffee maker adopting a separable design so that one can separately take out the container to facilitate the operation when pouring out coffee.

### BACKGROUND OF THE INVENTION

Nowadays, cafes stand in great numbers, and the rich fragrance generated when boiling coffee extremely attracts most people, more and more people form a habit of drinking coffee. There are many appliances for boiling coffee in the market, e.g., glass appliances utilizing the siphonal principle or distillation type electric products.

As shown in FIG. 1, a conventional pressure coffee maker comprises a base 10a, a filter unit 20a, a guide pipe 30a, and a container 40a. The filter unit 20a is disposed in the base 10a. The guide pipe 30a and the container 40a are disposed above the filter unit 20a. The container 40a is also connected with the base 10a. The filter unit 20a can receive coffee powder. Water is received in the base 10a. The bottom portion of the base 10a can be heated to boil the water therein so as to dissolve the coffee powder. When the coffee is finished, the guide pipe 30a can guide the coffee to be sprayed from through holes 31a and then flow into the container 40a for pouring out and drinking afterwards. In the above coffee maker, the container 40a and the base 10a are joined together. Therefore, when one wants to pour out coffee, he needs to pick the base 10a, the filter unit 20a, the guide pipe 30a, and the container 40a altogether, resulting in more laborsome operation and thus much inconvenience of user.

Accordingly, the above coffee maker has inconvenience and drawbacks in practical use. The present invention aims to resolve the problems in the prior art.

### SUMMARY OF THE INVENTION

The primary object of the present invention is to provide a separable coffee maker, which adopts a separable design to let the container be separable from the base, the filter unit, and the guide pipe. Therefore, one can separately take out the container to facilitate the operation when pouring out coffee.

To achieve the above object, the present invention provides a separable coffee maker, which comprises a base, a filter unit, a guide pipe, and a container. The base has a receiving space therein. The filter unit is disposed in the receiving space of the base. Through holes are formed on the guide pipe, which is disposed above the filter unit. The container has an inner pipe body therein. The inner pipe body is extended upwards from the bottom portion of the container. The container is separately placed on the base. The inner pipe body of the container is slipped onto the guide pipe. A separable coffee maker whose container can be separately taken out is thus formed.

The various objects and advantages of the present invention will be more readily understood from the following detailed description when read in conjunction with the appended drawing, in which:

### BRIEF DESCRIPTION OF THE DRAWINGS

FIG. 1 is a cross-sectional view of a prior art coffee maker;

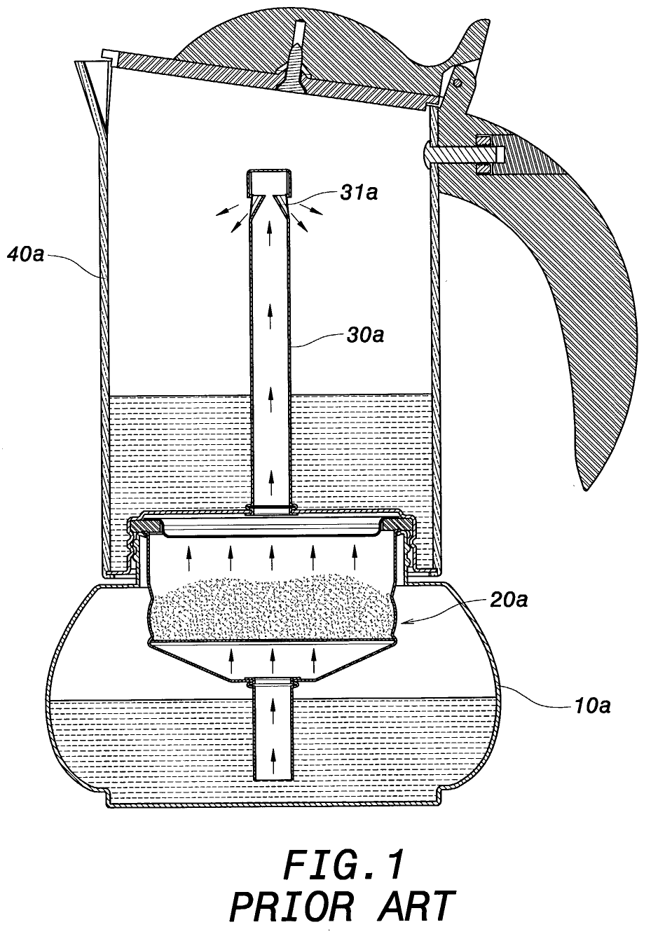

FIG. 2 is an exploded perspective view of the present invention;

FIG. 3 is a perspective assembly view of the present invention;

FIG. 4 is a cross-sectional view of the use state of the present invention; and

FIG. 5 is a perspective view of the separate state of the present invention.

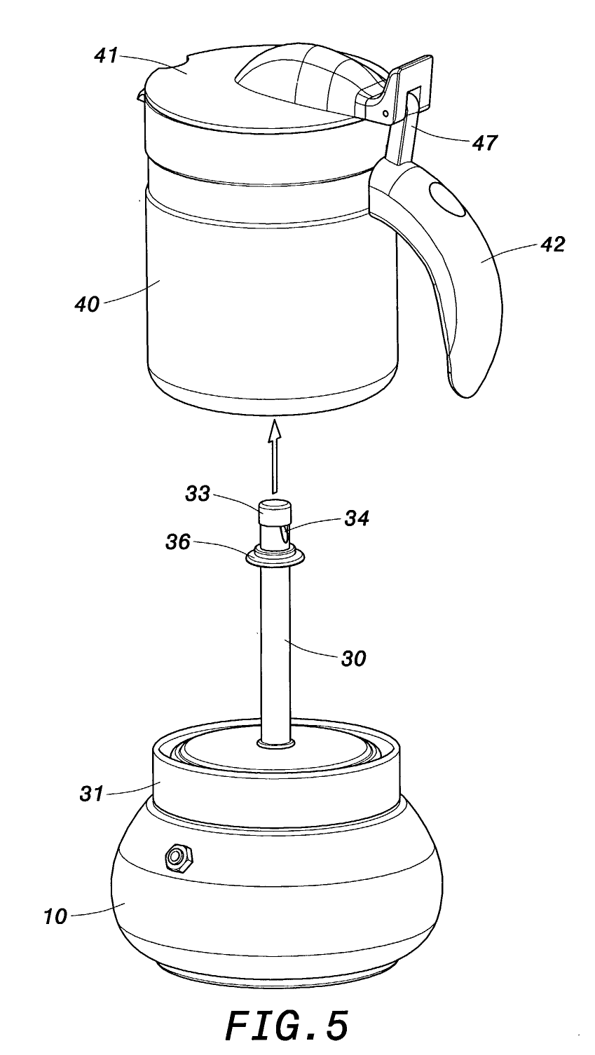

### DETAILED DESCRIPTION OF THE PREFERRED EMBODIMENTS

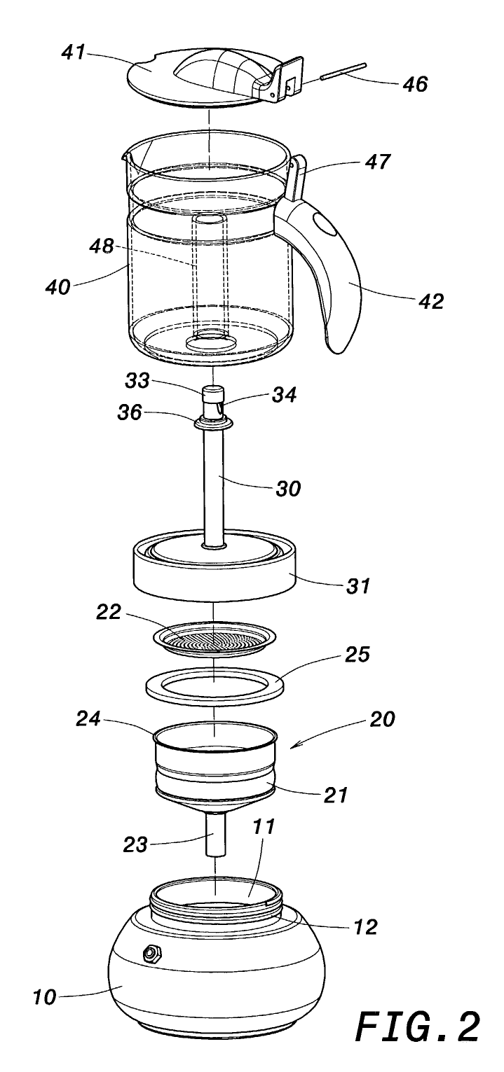

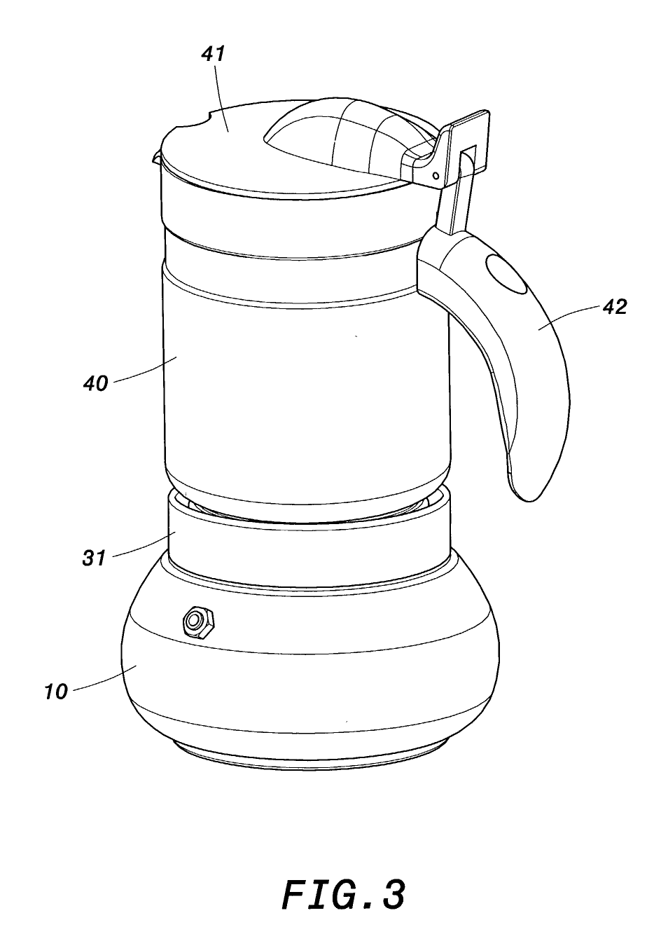

As shown in FIGS. 2, 3, and 4, the present invention provides a separable coffee maker, which comprises a base 10, a filter unit 20, a guide pipe 30, and a container 40. The base 10 is a hollow container made of metallic material. The top portion of the base 10 has an opening 11. The outer wall of the opening 11 has a thread portion 12. The base 10 has a receiving space 13 therein. The filter unit 20 is composed of a filter cup 21 and a filter net 22. The filter cup 21 is a hollow container with an open top portion and a funnelform bottom portion connected to a pipe body 23. The top portion of the filter cup 21 has also a ringed flange 24. When the filter cup 21 is placed in the receiving space 13 of the base 10, because the flange 24 is supported at the outer edge of the opening 11 at the top portion of the base 10, the filter cup 21 can be suspended in the receiving space 13 of the base 10. The filter net 22 covers the top portion of the filter cup 21. A spacer 25 is disposed between the filter cup 21 and the filter net 22. The spacer 25 is made of silica gel material to enhance airtightness between the filter cup 21 and the filter net 22.

The guide pipe 30 is disposed above the filter unit 20. The lower end of the guide pipe 30 is connected to a cover body 31. The inner wall of the cover body 31 has a thread portion 32, which is screwed to the thread portion 12 of the base 10 so that the guide pipe 30 and the cover body 31 can be joined at the opening 11 of the base 10. The guide pipe 30 and the cover body 31 are situated above the filter unit 20. An end cover 33 is slipped and fixed onto the upper end of the guide pipe 30 to shut the upper end of the guide pipe 30. Two through holes 34 are formed on the sidewall and near the upper end of the guide pipe 30 so that boiled coffee can flow out. The sidewall of the guide pipe 30 has a ringed positioning groove 35. A ringed retaining piece 36 is slipped onto the positioning groove 35. The retaining piece 36 is made of silica gel material.

The container 40 is a glass cup, a steel cup, or a plastic cup with an open top portion, which is connected with an openable upper lid 41. The sidewall of the container 40 is connected with a handle 42. A fixing seat 43 is fixedly disposed on the sidewall of the container 40 in advance, and a screw 44 passes through the handle 42 and the fixing seat 43 and is then screwed to a nut 45 so that the handle 42 can be fixed on the container 40 in screwing way. One side of the upper lid 41 uses a pivot 46 to pass through a pivotal seat 47 pivotally joined at the upper end of the handle 42 so that the upper lid 41 can be pivotally joined at the top portion of the container 40. The container 40 has an inner pipe body 48 at the center therein. The inner pipe body 48 is extended upwards from the bottom portion of the container 40. Both the top portion and the bottom portion of the inner pipe body 48 are open. The bore of the inner pipe body 48 is larger than that of the guide pipe 30. The container 40 is placed on the cover body 31 at the top portion of the base 10. The inner pipe body 48 of the container 40 is slipped onto the guide pipe 30. The retaining piece 36 is situated at a predetermined height above the gap between the inner pipe body 48 and the guide pipe 30. A separable coffee maker of the present invention is thus formed.

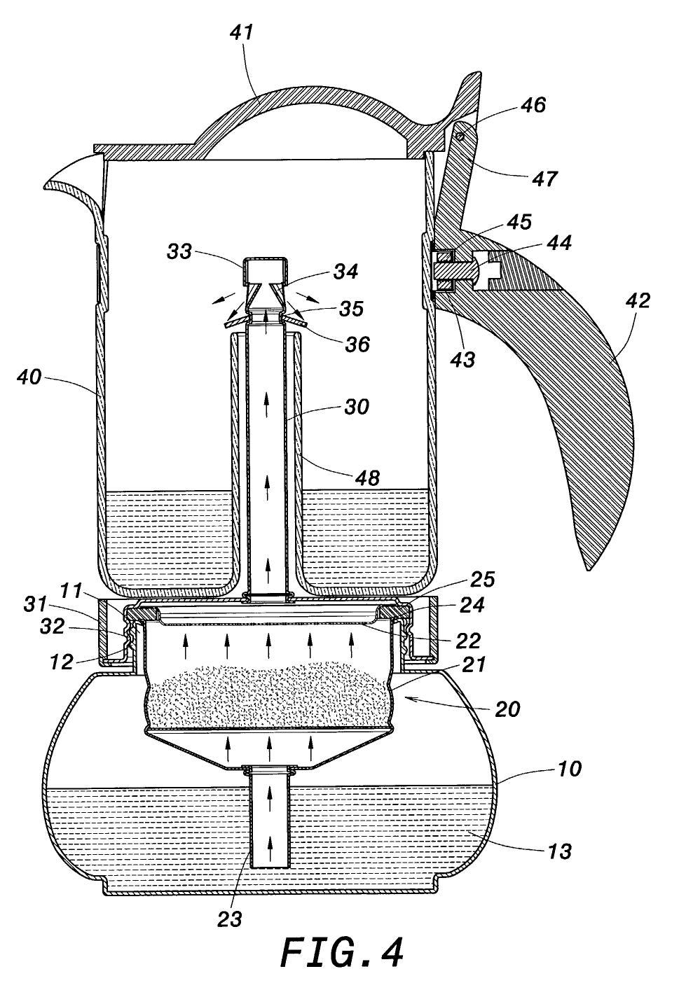

As shown in FIG. 4, the filter unit 20 of the present invention is used to receive coffee powder. Water is received in the receiving space 13 of the base 10. The bottom portion of the base 10 can be heated to boil water so as to dissolve the coffee powder. When the coffee is finished, the guide pipe 30 guides the coffee to be sprayed out from the through holes 34 and then directly flow into the container for pouring out and drinking afterwards.

The present invention is characterized in that the container 40 adopts a separable design. The container 40 can be separated from the base 10, the filter unit 20, and the guide pipe 30. Therefore, when one wants to pour out coffee, the container 40 can be separately taken out. It is not necessary to take out the base 10, the filter unit 20, and the guide pipe 30 along with the container 40. The operation is thus more laborsaving and easy. Moreover, the container 40 can be easily slipped in and positioned along the guide pipe 30.

Furthermore, the retaining piece 36 is disposed above the gap between the inner pipe body 48 and the guide pipe 30 to effectively prevent coffee sprayed out from the through holes 34 of the guide pipe 30 from splashing into the gap.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A separable coffee maker, comprising:
a base having a receiving space therein;
a filter unit disposed in said receiving space of said base;
a guide pipe having through holes thereon and disposed above said filter unit;
a container having an inner pipe body therein, said inner pipe body being extended upwards from a bottom portion of said container, said container being placed above said base, said inner pipe body of said container being slipped onto said guide pipe; and
a ringed retaining piece disposed above said guide pipe, said retaining piece being situated above a gap between said inner pipe body and said guide pipe.

2. The separable coffee maker as claimed in claim 1, wherein said base has an opening at a top portion thereof, said opening has a thread portion on an outer wall thereof, a lower end of said guide pipe is connected with a cover body, said cover body has a thread portion on an inner wall thereof, said thread portion of said cover body is screwed to said thread portion of said base so that said guide pipe and said cover body can be connected with said base.

3. The separable coffee maker as claimed in claim 1, wherein said filter unit comprises a filter cup and a filter net, said filter cup has an open top portion and a funnelform bottom portion connected to a pipe body, said filter cup has also a ringed flange at the top portion thereof, said flange is supported on said base, said filter net covers the top portion of said filter cup, a spacer is disposed between said filter cup and said filter net.

4. The separable coffee maker as claimed in claim 1, wherein an end cover is slipped and fixed onto an upper end of said guide pipe to shut the upper end of said guide pipe, and said through holes are disposed on a sidewall and near an upper end of said guide pipe.

5. The separable coffee maker as claimed in claim 1, wherein said guide pipe has a ringed positioning groove on a sidewall thereof, and said ringed retaining piece is slipped into said positioning groove.

6. The separable coffee maker as claimed in claim 1, wherein said container is a glass cup, a steel cup, or a plastic cup.

7. The separable coffee maker as claimed in claim 1, wherein said container has an open top portion connected with an openable lid, and a handle is connected with a sidewall of said container.
